(19) United States
(12) Patent Application Publication
(10) Pub. No.: US 2022/0298805 A1
(43) Pub. Date: Sep. 22, 2022

(54) ACCESS PANEL WITH ENCASED SPRING

(71) Applicant: Novera Products Inc., Oro-Medonte (CA)

(72) Inventor: Jerzy SZYJKOWSKI, Oro-Medonte (CA)

(73) Assignee: Novera Products Inc., Oro-Medonte (CA)

(21) Appl. No.: 17/698,083

(22) Filed: Mar. 18, 2022

Related U.S. Application Data
(60) Provisional application No. 63/207,740, filed on Mar. 19, 2021.

(51) Int. Cl. E04F 19/08; E05B 65/00

(52) U.S. Cl. CPC E04F 19/083; E05B 65/006; E05C 19/028

(57) ABSTRACT

There is provided an access panel for releasably covering an aperture in a structure, the access panel including a panel member having inner and outer sides, and a panel stop extending from said inner side. The access panel includes a mounting member attached to the inner side adjacent a first edge to engage the structure. The access panel also includes a movable clip member slidably mounted on the panel member. The clip member comprises a casing and a mounting flange secured to a first end of the casing. The casing is linearly movable over the panel stop. The mounting flange is adapted to engage the structure proximate an opposed second edge of the panel member. The access panel also includes a spring situated within the casing between the first end of the casing and the panel stop for biasing the clip member toward the second edge in use.

### CROSS-REFERENCE TO RELATED APPLICATION(S)

This application claims the benefit of U.S. Provisional Patent Application No. 63/207,740, filed Mar. 19, 2021, which is incorporated by reference herein in its entirety.

### FIELD

This invention relates to access panels and doors which can be used to cover openings in walls and ceilings, and to provide ready access to an enclosed space or installation through the opening.

### BACKGROUND

It is well known in the building industry to provide an access door or panel which can include a door or panel frame and a hinged panel member on which a locking device can be mounted. The locking device may take the form of a latch, such as a hook that is connectable to an eye member, a pivoting bar, or a sliding bar. A frame can be mounted on the wall or in the ceiling. This frame can be mounted the movable panel or door or, in the alternative, the access panel can be mounted directly to wall paneling or ceiling panels in a manner so as to cover the opening formed therein. These known access doors and panels generally require a certain size and shape for the opening formed in the wall or ceiling in order to ensure that the access panel can be properly installed.

As indicated so called “frameless” access panels are known and are designed to grip the inside surface of a wall or ceiling paneling which limits their possible use. Access panels of this type can generally not be used to cover an opening in a brick or concrete wall, for example.

U.S. Pat. No. 5,765,212 describes and illustrates an access panel that incorporates a frame clamping device. This panel is in the form of a plate having opposite side edges and a positioning frame extending rearwardly from the rear surface. The panel has two elongate clamping elements, each extending towards a respective one of the side edges from a central region of the plate. Each clamping element is made of a resilient spring material so that its outer end can be pulled away from the plate during installation.

U.S. Pat. No. 5,361,541 describes a movable access door or panel that has two pivoting clips for removably attaching the panel to a structure. Each clip or clamping member is pivotally mounted adjacent a side edge of the panel. A spring biases the clips to swing them to a position whereby they releasably clamp edge sections of the structure.

U.S. Pat. No. 6,618,996 describes an access panel with a sliding clip member that is biased in place within an aperture in a structure with a spring mechanism.

There continues to be a need for an improved access panel for covering an aperture in a structure, such as a building wall, this access panel being relatively inexpensive to construct and capable of fitting apertures of varying size.

### SUMMARY

In some examples, the present disclosure describes an access panel for releasably covering an aperture in a structure, said access panel comprising a substantially planar panel member having inner and outer sides and of a size to cover said aperture, said panel member having a panel stop extending rearwardly from said inner side; a first mounting member having an inner edge rigidly attached to said panel member adjacent a first edge of the panel member and extending rearwardly from said inner side of said panel member, said first mounting member being arranged to engage said structure when said access panel covers said aperture; a movable clip member mounted on said panel member and extending rearwardly from said inner side of said panel member, said clip member comprising a casing and a mounting flange secured to a first end of said casing, said casing situated in covering relation over said panel stop and linearly movable relative to said panel stop in a direction parallel to said inner side of said panel member from a first position spaced from a second edge of said panel member, which is opposite said first edge, to a second position wherein said mounting flange is adjacent to said second edge, said mounting flange being adapted to engage said structure proximate said second edge when said access panel covers said aperture; and a spring situated within said casing, and positioned between a first end of said casing and said panel stop, for biasing said clip member toward said second position.

In some examples, the present disclosure describes an access panel for releasably covering an aperture in a structure, said access panel comprising a substantially planar panel member having inner and outer sides and of a size to cover said aperture, said panel member having a guide track formed thereon, and a panel stop extending rearwardly from said inner side within said guide track, said guide track comprising a pair of spaced apart and generally parallel guide rails, said panel stop positioned within said guide track; a mounting member attached to said panel member adjacent to and spaced from a first edge of the panel member and extending rearwardly from said inner side of said panel member, said mounting member comprising an elongate flange extending substantially parallel to said first edge, said elongate flange having an outer surface facing said first edge and sloping at an acute angle relative to said inner side of said panel member in a direction toward said first edge, said elongate flange further comprising one or more ridges extending from said outer surface and being adapted to engage said structure when said access panel covers said aperture; a movable clip member mounted on said panel member for sliding movement along said guide track and extending rearwardly from said inner side of said panel member, said clip member comprising a casing and a mounting flange secured to a first of said casing, said casing situated in covering relation over said panel stop and linearly movable relative to said panel stop in a direction parallel to said inner side from a first position spaced from a second edge of said panel member to a second position wherein said mounting flange is adjacent to said second edge, said mounting flange adapted to engage said structure when said access panel covers said aperture; and a spring situated within said casing and positioned between said first end of said casing and said panel stop for biasing said clip member toward said second position.

In some examples, the present disclosure describes an access panel for releasably covering an aperture in a structure, said access panel comprising (i) a substantially planar panel member having inner and outer sides and of a size to cover said aperture, said panel member comprising: a guide track formed from a pair of spaced apart and generally parallel guide rails situated on said inner side, a panel stop extending rearwardly from said inner side positioned between said guide rails; and a raised outer edge extending around the perimeter of said planar panel member; (ii) a mounting member rigidly attached to said panel member adjacent to and spaced from a first edge of the panel member and extending rearwardly from said inner side of said panel member, said mounting member comprising an elongate flange extending substantially parallel to said first edge, said elongate flange having an outer surface facing said first edge and sloping at an acute angle relative to said inner side of said panel member in a direction toward said first edge, said elongate flange further comprising one or more ridges extending from said outer surface and being adapted to engage said structure when said access panel covers said aperture; (iii) a movable clip member mounted on said panel member for sliding movement along said guide track and extending rearwardly from said inner side of said panel member, said clip member comprising a casing and a mounting flange secured to a first end of said casing, said casing situated in covering relation over said panel stop and comprising laterally opposed sliders dimensioned to slidably engage the pair of guide rails on either side of said panel stop to permit linear movement relative to said panel stop in a direction parallel to said inner side from a first position spaced from a second edge of said panel member, to a second position wherein said mounting flange is adjacent to said second edge, said mounting flange comprising an outer surface that faces said second edge and that slopes at an acute angle relative to said inner side of said panel member, said mounting flange further comprising one or more ridges extending from said outer surface of said mounting flange and adapted to engage said structure when said access panel covers said aperture, wherein said movable clip is flexibly resilient to permit said movable clip to flex and allow said sliders to engage within said guide rails during assembly; and (iv) a spring situated within said casing and positioned between said first end of said casing and said panel stop for biasing said clip member toward said second position.

### BRIEF DESCRIPTION OF THE DRAWINGS

Reference will now be made, by way of example, to the accompanying drawings which show example embodiments of the present application, and in which:

FIG. 1 is an upper perspective view of an inner side of an access panel according to an embodiment of the present disclosure.

FIG. 2 is cross-sectional view of the access panel of FIG. 1 along A-A.

FIG. 3 is cross-sectional view of the access panel of FIG. 1 along B-B.

FIG. 4 is an upper perspective view of an inner side of an access panel according to another embodiment of the present disclosure, in which a portion of a casing of a movable clip member is removed.

Similar reference numerals may have been used in different figures to denote similar components.

### DESCRIPTION OF EXAMPLE EMBODIMENTS

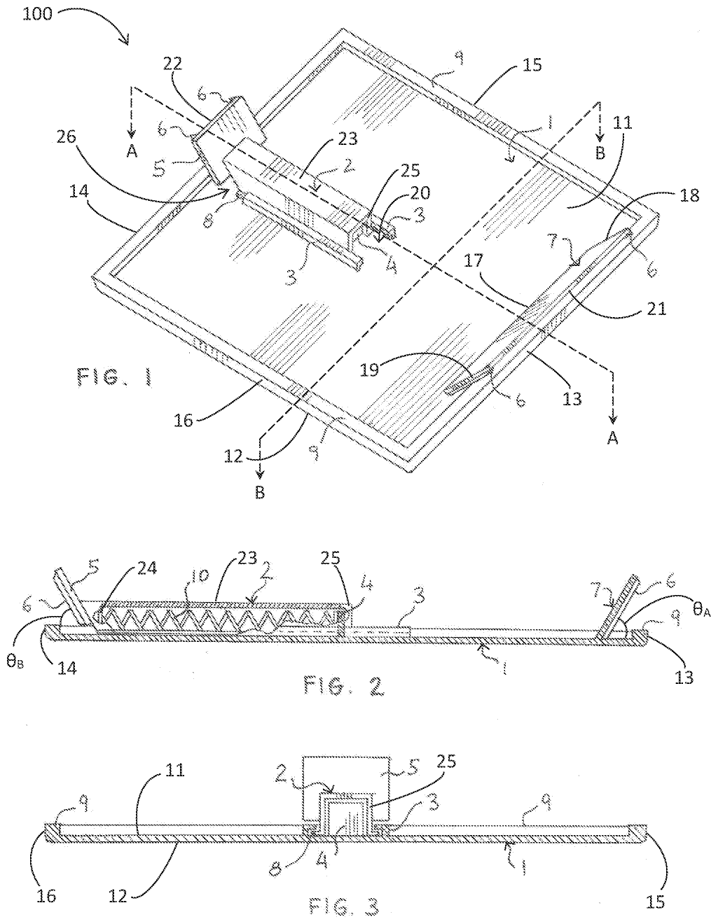

An embodiment of an access panel 100 constructed in accordance with the invention is shown in FIGS. 1 to 3. It will be understood that this access panel 100 is capable of releasably covering an aperture in a structure such as a building wall or a building ceiling. Access panel 100 generally comprises a substantially planar panel member 1, a mounting member 7 secured thereto, a movable clip member 2 slidable coupled to panel member 1, and a spring 10 for biasing movable clip member 2 relative to panel member 1.

Panel member 1 is shown having an inner side 11 and an outer side 12. Panel member 1 further has a first edge 13, an opposed second edge 14, and side edges 15, 16 extending between first and second edges 13, 14. In the present embodiment, panel member 1 further has a panel stop 4 extending rearwardly from inner side 11. In the embodiment illustrated in FIGS. 1 and 3, panel stop 4 is square-shaped and positioned generally in the middle of panel member 1. Panel stop 4 may be structurally integrated with panel member 1. Alternative embodiments may have a panel stop 4 that has a different shape, and/or is situated at a different position on panel member 1.

Access panel 100 is of a size to cover an aperture in a structure. The illustrated panel member is square or rectangular, but other shapes are possible, for example circular or elliptical. Generally speaking, the panel member can be shaped to correspond substantially to the shape of the aperture, if desired.

In the depicted embodiment, panel member 1 has a raised outer edge 9 extending along second edge 14, where raised outer edge 9 extends rearwardly from inner side 11. In particular, raised outer edge 9 is shown to extend around the entire perimeter of inner side 11, along first edge 13 and side edges 15, 16. Raised outer edge 9 may act has a clip stop for movable clip 2 (discussed further below). The presence of raised outer edge 9 around the perimeter may also help to provide structural rigidity to access panel 100 as a whole.

Panel member 1 is further shown to have a guide track 20 formed therein, where panel stop 4 is positioned within guide track 20. In particular, guide track 20 comprises a pair of guide rails 3, L-shaped guide rails, positioned on either side of panel stop 4. Guide rails 3 are shown extending from panel stop 4 towards second edge 14 in parallel, but terminating before reaching second edge 14. A space 26 is positioned between the ends of guide rails 3 and second edge 14 to help allow clip member 2 to engage with guide rails 3 during assembly (as further discussed below). To that end, panel member 1 may be flexibly resilient so as to assist movable clip member 2 to be slidably coupled with guide rails 3. In that manner, panel member 1 may be made of molded plastic or metal.

Guide rails 3 may have other forms instead of the illustrated L-shaped track. For example, it is possible for guide rails 3 to have a T-shaped cross section or a dovetail cross section. The track can extend along a groove or elongate recess formed in panel member 1.

A mounting member 7 has an inner edge 17 that is rigidly attached to inner side 11 of panel member 1 that is adjacent first edge 13 thereof. Mounting member 7 extends rearwardly from inner side 11 of panel member 1 and is arranged to engage the structure when access panel 100 covers the aperture. Mounting member 7 of access panel 100 is an elongate flange that is rigidly attached to panel member 1 and extends substantially parallel to first edge 13. Preferably, inner edge 17 of mounting member 7 is spaced a relatively short distance from first edge 13 as shown. In this way, there is an edge portion between mounting member 7 and first edge 13 which can engage the outer surface of the wall or ceiling. As shown, mounting member 7 has an outer surface 21 facing towards first edge 13 that slopes at an acute angle indicated at θ_{A} in FIG. 2 relative to inner side 11 of panel member 1. Mounting member 7 also has opposite ends 18, 19 that are spaced from the side edges 15, 16 respectively, thus allowing access panel 100 to be mounted in a rectangular or square aperture that may vary in its size to some extent.

It will be understood that because of the slope of the outer surface of the elongate flange, the elongate flange is capable of engaging an inner edge of a wall panel or ceiling panel. If the elongate flange is made sufficiently wide, it can accommodate wall paneling of various thicknesses while still adequately engaging and holding access panel 100 along one side edge.

In the illustrated embodiment, mounting member 7 further has one or more ridges 6 extending therefrom which are positioned to engage the structure when access panel 100 covers the aperture. In particular, mounting member 7 (as depicted in the figures) includes two ridges 6 extending from inner edge 17 along outer surface 21 of mounting member 7, where ridges 6 are positioned at opposite ends 18, 19. Alternative applications may involve a different number of ridges 6 positioned at different places and orientations along outer surface 21. Ridges 6 may be relatively sharp for anchoring into the sides of an opening in the paneling of walls or ceilings and may extend in a direction perpendicular to outer surface 21 of mounting member 7. Thus, ridges 6 help to promote firm installation.

Access panel 10 also has movable clip member 2. Movable clip member 2 is slidably mounted on panel member 1 and is guided in its movements by guide track 20, such as guide rails 3. Movable clip member 2 extends or projects rearwardly from inner side 11 as shown and is linearly movable in a direction parallel to planar panel member 1 or parallel to inner side 11 thereof. It should be understood that clip member 2 is movable from a first position as shown in FIG. 1 to a second position. In the first position, clip member 2 is spaced from second edge 14 of panel member 1. In the second position, clip member 2 is adjacent second edge 14. The amount by which clip member 2 is moved away from second edge 14 in use depends, to some extent, on the size of the aperture in the wall or ceiling. The clip member 2 is adapted to engage the structure, for example the building wall, when access panel 100 covers the aperture. The illustrated clip member 2 has a transversely extending mounting flange 5 which can be planar as shown and is preferably positioned midway between the side edges 15, 16 of panel member 1.

Mounting flange 5 in the present embodiment has an outer surface 22 which faces towards second edge 14 and which slopes at an acute angle relative to the inner side 18 of the panel. This acute angle is indicated as θ_{B} in FIG. 2. Because of the slope of mounting flange 5, clip member 2 is better able to grip or engage the building wall and it is also able to grip or engage a wall panel or ceiling panel in a manner similar to mounting member 7.

Also similar to mounting member 7, the depicted mounting flange 5 further has one or more ridges 6 extending therefrom which are positioned to engage the structure when access panel 100 covers the aperture. In particular, mounting flange 5 depicted in FIGS. 1 and 2 includes two ridges 6 extending along outer surface 22 of mounting flange 5, which are also positioned at opposite ends of mounting flange 5. Alternative applications may involve a different number of ridges 6 positioned at different places along outer surface 22. Ridges 6 are shown to be relatively sharp for anchoring into the sides of an opening in the paneling of walls or ceilings and may extend in a direction perpendicular to outer surface 22 of mounting flange 5. Thus, ridges 6 help to promote firm installation.

Clip member 2 further includes a casing 23 extending from mounting flange 5, whereby mounting flange 5 is secured to a first end of casing 23. Casing 23, as shown, extends substantially parallel to guide rails 3 and is situated in covering relation over panel stop 4. As casing 23 forms part of clip member 2, it too is linearly movable relative to panel stop 4 in a direction parallel to panel member 1 from the first position spaced from second edge 14 to the second position that is adjacent to second edge 14. In the present embodiment, casing 23 includes a pair of sliders 8 dimensioned to slidably engage with guide rails 3 on either side of panel stop 4. Sliders 8 can be integrally connected to casing 23.

In the depicted embodiment, the first end of casing 23 (that is adjacent to mounting flange 5) is a closed end 24, and a second opposed end of casing 23 is an open end 25 with an opening. As best seen in FIG. 3, the opening may be shaped and dimensioned to slidably receive panel stop 4 therethrough. In that manner, casing 23 can be mounted for sliding movement along guide rails 3 by means of sliders 8 around panel stop 4.

Clip member 2 is flexibly resilient to permit clip member 2 to flex and engage with panel member 1 during assembly. In particular, clip member 2 may be flexibly resilient so as to permit clip member 2 to flex and allow sliders 8 to engage within guide rails 3 during assembly. In that manner, clip member 2 may be made of molded plastic or metal.

A spring, indicated generally at 10, is situated within casing 23 and is positioned between first/closed end 24 of casing 23 and panel stop 4 to bias mounting flange 5 of clip member 2 towards second edge 14 and, thus, into engagement with the building wall. In this manner, spring 10 biases clip member 2 towards the second or engagement position when access panel 100 is mounted on the structure and covers the aperture. Spring 10, illustrated in FIGS. 1 and 2, is a compression spring that is positioned within casing 23 and extends between first/closed end 24 of casing 23 and panel stop 4. Other resiliently biasing components may be used instead of the compression spring.

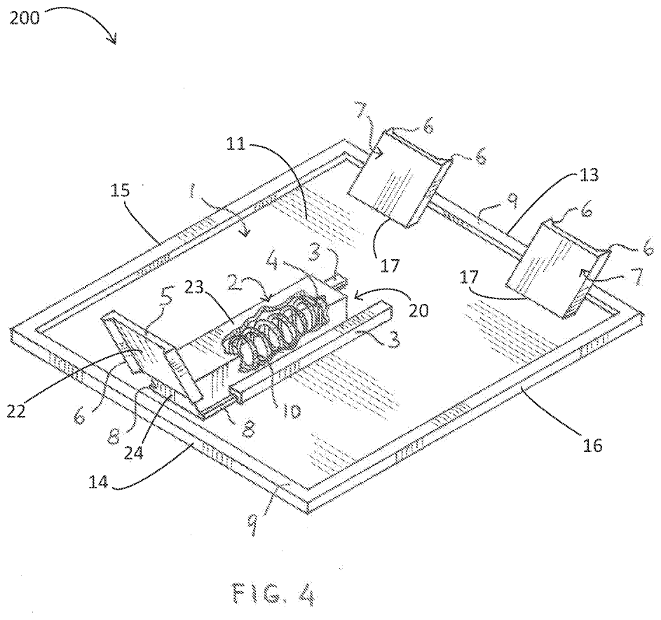

Turning now to the embodiment 200 of the access panel illustrated in FIG. 4, this embodiment may be similar in its construction to the first access panel 100 of FIGS. 1 to 3, except for mount member 7. Access panel 200 features two fixed mounting flanges 7, rather than one as in access panel 100. In the illustrated embodiment, the two mounting flanges 7 of access panel 200 have inner edges 17 that are rigidly attached to panel member 1 adjacent first edge 13, and extending rearwardly from inner side 11 of said panel member 1. The two mounting members 7 are positioned in parallel, side-by-side with a space therebetween. They are also shown to be spaced apart from first edge 13, and are smaller than mounting flange 7 of access panel 100. Each of mounting flanges 7 in access panel 200 also includes raised sharp ridges 6, such as two ridges 6 per mounting flange 7, with each ridge located at an outer edge of the mounting flanges 7.

Clip member 2 is shown with a portion removed to partially expose spring 10 positioned inside. At one end of spring 10 is panel stop 4. Tension of spring 10 on first/closed end 24 of clip member 2 biases clip member 2 towards second edge 14 until clip member 2 rests against raised outer edge 9 at second edge 14. When installed onto a building, mounting flange 5 and mounting flanges 7 will fasten onto the inner edges of the opening when access panel 200 covers the opening, providing for firm, non-slip installations.

Known access panels of similar type and function, all use an exposed metal spring, such as a leaf spring, a coil spring or a torsion spring, for holding the access panel in place. This exposed metal spring creates safety hazards, especially when they are installed over, or near, electrical equipment. In such installations, the exposed metal spring can come in contact with the electrical installation, causing it to short and potentially causing a fire. Sharp edges or ends of the metal springs may also cause harm to a user who is handling and/or installing the prior types of access panels. Thus, the disclosed configuration encloses spring 10 within casing 23, where movement of spring 10 is also guided by casing 23. This further helps ensure proper alignment and performance of the compression spring. In this manner, access panel 100, 200 is also safer in use during handling and installation. There are no exposed sharp ends or sharp metal edges, which also helps to enhance the overall appearance.

Another weakness of known access panels of similar type and function, is that they can shift or slide in directions along surfaces of the mounting member. Such movement may occur during and/or after installation due to air drafts or shaking of the paneling of walls and ceilings during construction. In this manner, ridges 6 help to prevent unwanted movement or sliding of access panel 100, 200 after installation. The described sharp edges of ridges 6 on mounting flange 5 and mounting member 7, when installed to cover an opening in paneling such as drywall, dig into the sides of said opening. This helps result in firm installation, where the unwanted movement or sliding of access panel 100, 200 along the surface of the paneling is prevented.

The disclosed access panel also provides for simpler assembly by slidably engaging clip member 2 with panel member 1. In particular, open end 25 of casing 23, along with spring 10 situated therein, may be inserted into guide track 20 over raised outer edge 9 at second edge 14 by sliding sliders 8 between guide rails 3. The flexing of flexibly resilient clip member 2 and/or panel member 1 (as described above), allows sliders 8 of casing 23 to enter guide rails 3 over raised outer edge 9 through space 26 between raised edge 9 at second edge 14 of panel member 1 and the beginning of guide rails 3. As casing 23 slides along guide rails 3, it will pass over panel stop 4 (situated between guide rails 3), at which point, spring 10 will come in contact with panel stop 4 and be compressed between panel stop 4 and closed end 24 of casing 23. The flexible resilience of clip member 2 and/or panel member 1 allows casing 23 and/or panel member 1 to bend sufficiently for mounting flange 5 to pass over raised outer edge 9 before snapping into place. The biasing of spring 10 between panel stop 4 and first/closed end 24 of clip member 2 pushes mounting flange 5 towards second edge 14, where raised outer edge 9 may then act as a clip stop for mounting flange 5. Thus assembled, clip member 2 may slide back and forth along guide rails 3 and access panel 100, 200, and is ready for installation in a building construction.

It will be appreciated that the access panels of the present invention are constructed so that they can be successfully and safely installed to cover an aperture or opening in a brick or concrete wall. The access panels disclosed can be installed to cover a range of apertures of varying size by placing the spring loaded clip members 2 on one edge of the aperture first, and then sliding access panel 100, 200 at a slight angle to the surface of the wall or ceiling in the direction of the spring loaded clip member 2. At the point where the fixed mounting member 7 is in a position to clear the opposite edge of the aperture, panel member 1 can then be fully inserted into the aperture by a pivoting motion. The spring causes mounting flange 5 and mounting member 7 to be pressed against the opposite sides of the aperture. Ridges 6 on both mounting flange 5 and mounting member 7 help ensure a firm and fast installation of the access panel. Casing 23 provides protection for the user from the sharp edges and ends of the internal metal spring, while also ensuring that the metal spring does not come into contact with external electrical connections.

The embodiments of the present disclosure described above are intended to be examples only. The present disclosure may be embodied in other specific forms. Alterations, modifications and variations to the disclosure may be made without departing from the intended scope of the present disclosure. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. An access panel for releasably covering an aperture in a structure, said access panel comprising:
a substantially planar panel member having inner and outer sides and of a size to cover said aperture, said panel member having a panel stop extending rearwardly from said inner side;
a first mounting member having an inner edge rigidly attached to said panel member adjacent a first edge of the panel member and extending rearwardly from said inner side of said panel member, said first mounting member being arranged to engage said structure when said access panel covers said aperture;
a movable clip member mounted on said panel member and extending rearwardly from said inner side of said panel member, said clip member comprising a casing and a mounting flange secured to a first end of said casing, said casing situated in covering relation over said panel stop and linearly movable relative to said panel stop in a direction parallel to said inner side of said panel member from a first position spaced from a second edge of said panel member, which is opposite said first edge, to a second position wherein said mounting flange is adjacent to said second edge, said mounting flange being adapted to engage said structure proximate said second edge when said access panel covers said aperture; and
a spring situated within said casing, and positioned between a first end of said casing and said panel stop, for biasing said clip member toward said second position.

2. The access panel according to claim 1, wherein said clip member is flexibly resilient to permit said clip member to flex and engage with said panel member during assembly.

3. The access panel according to claim 1, wherein said first end of said casing is a closed end, said casing having a second opposed end dimensioned to slidably receive the panel stop therethrough.

4. The access panel according to claim 3, wherein said planar panel member further comprises a raised outer edge along said second edge, said raised outer edge extending rearwardly from said inner side.

5. The access panel according to claim 4, wherein said raised outer edge extends around the perimeter on said inner side.

6. The access panel according to claim 4, wherein said panel member has a guide track comprising a pair of guide rails positioned on either side of said panel stop, said casing mounted for sliding movement along said guide track about said panel stop.

7. The access panel according to claim 6, wherein said pair of guide rails extends from said panel stop towards said second edge with a space between said guide rails and said raised outer edge.

8. The access panel according to claim 7, wherein said casing comprises a pair of laterally opposed sliders dimensioned to slidably engage the pair of guide rails on either side of said panel stop.

9. The access panel according to claim 7, wherein said clip member is flexibly resilient to permit said clip member to flex and engage with said guide rails during assembly.

10. The access panel according to claim 9, wherein said spring comprises a compression spring positioned within said casing and extending between said first end of said casing and said panel stop.

11. The access panel according to claim 1, wherein said first mounting member comprises one or more ridges extending therefrom and positioned to engage said structure when said access panel covers the aperture.

12. The access panel according to claim 11, wherein said mounting flange comprises one or more ridges extending therefrom and positioned to engage said structure when the access panel covers the aperture.

13. The access panel according to claim 1, further comprising a second mounting member, having an inner edge rigidly attached to said panel member adjacent said first edge of said panel member and extending rearwardly from said inner side of said panel member, said second mounting member being positioned beside, and spaced apart from, the first mounting member to engage said structure when of said access panel covers the aperture.

14. An access panel for releasably covering an aperture in a structure, said access panel comprising:
a substantially planar panel member having inner and outer sides and of a size to cover said aperture, said panel member having a guide track formed thereon, and a panel stop extending rearwardly from said inner side within said guide track, said guide track comprising a pair of spaced apart and generally parallel guide rails, said panel stop positioned within said guide track;
a mounting member attached to said panel member adjacent to and spaced from a first edge of the panel member and extending rearwardly from said inner side of said panel member, said mounting member comprising an elongate flange extending substantially parallel to said first edge, said elongate flange having an outer surface facing said first edge and sloping at an acute angle relative to said inner side of said panel member in a direction toward said first edge, said elongate flange further comprising one or more ridges extending from said outer surface and being adapted to engage said structure when said access panel covers said aperture;
a movable clip member mounted on said panel member for sliding movement along said guide track and extending rearwardly from said inner side of said panel member, said clip member comprising a casing and a mounting flange secured to a first of said casing, said casing situated in covering relation over said panel stop and linearly movable relative to said panel stop in a direction parallel to said inner side from a first position spaced from a second edge of said panel member to a second position wherein said mounting flange is adjacent to said second edge, said mounting flange adapted to engage said structure when said access panel covers said aperture; and
a spring situated within said casing and positioned between said first end of said casing and said panel stop for biasing said clip member toward said second position.

15. The access panel according to claim 14 wherein said mounting flange of said clip member has an outer surface that faces said second edge and that slopes at an acute angle relative to said inner side of said panel member.

16. The access panel according to claim 15, wherein said mounting flange further comprises one or more ridges extending from said outer surface of said mounting flange and adapted to engage said structure when said access panel covers said aperture.

17. The access panel according to claim 14, wherein said planar panel member further comprises a raised outer edge along said second edge, said raised outer edge extending rearwardly from said inner side.

18. The access panel according to claim 14, wherein said movable clip is flexibly resilient to permit said movable clip to flex and engage within said guide rails during assembly.

19. The access panel according to claim 18 wherein said spring comprises a compression spring extending between said first end of said casing and said panel stop.

20. An access panel for releasably covering an aperture in a structure, said access panel comprising:
(i) a substantially planar panel member having inner and outer sides and of a size to cover said aperture, said panel member comprising,
a guide track formed from a pair of spaced apart and generally parallel guide rails situated on said inner side,
a panel stop extending rearwardly from said inner side positioned between said guide rails,
a raised outer edge extending around the perimeter of said planar panel member;
(ii) a mounting member rigidly attached to said panel member adjacent to and spaced from a first edge of the panel member and extending rearwardly from said inner side of said panel member, said mounting member comprising an elongate flange extending substantially parallel to said first edge, said elongate flange having an outer surface facing said first edge and sloping at an acute angle relative to said inner side of said panel member in a direction toward said first edge, said elongate flange further comprising one or more ridges extending from said outer surface and being adapted to engage said structure when said access panel covers said aperture;
(iii) a movable clip member mounted on said panel member for sliding movement along said guide track and extending rearwardly from said inner side of said panel member, said clip member comprising,
a casing and a mounting flange secured to a first end of said casing,
said casing situated in covering relation over said panel stop and comprising laterally opposed sliders dimensioned to slidably engage the pair of guide rails on either side of said panel stop to permit linear movement relative to said panel stop in a direction parallel to said inner side from a first position spaced from a second edge of said panel member to a second position wherein said mounting flange is adjacent to said second edge,
said mounting flange comprising an outer surface that faces said second edge and that slopes at an acute angle relative to said inner side of said panel member, said mounting flange further comprising one or more ridges extending from said outer surface of said mounting flange and adapted to engage said structure when said access panel covers said aperture,
wherein said movable clip is flexibly resilient to permit said movable clip to flex and engage within said guide rails during assembly; and
(iv) a spring situated within said casing and positioned between said first end of said casing and said panel stop for biasing said clip member toward said second position.
